(19) United States
(12) Patent Application Publication
(10) Pub. No.: US 2007/0207272 A1
(43) Pub. Date: Sep. 6, 2007

(54) METHOD AND APPARATUS FOR MAGNETIC MIXING IN MICRON SIZE DROPLETS

(76) Inventors: Ishwar K. Puri, Blacksburg, VA (US); Ranjan Ganguly, Kolkata (IN); Ashok Sinha, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/681,344

(22) Filed: Mar. 2, 2007

Related U.S. Application Data
(60) Provisional application No. 60/778,389, filed on Mar. 3, 2006.

(51) Int. Cl. G21H 1/00; B01F 13/08; B05C 5/02

(52) U.S. Cl. 427/457; 427/212; 366/274; 118/621

(57) ABSTRACT

Active mixing by magnetic stirring is demonstrated inside a picoliter-size liquid droplet. Magnetic microspheres are added to the droplet, which form aligned chains under the influence of a homogeneous magnetic field. When the magnetic field is rotated, the chains also rotate synchronously. Viscous interaction between the particle-chains and the liquid induces advective motion inside the droplet thereby enhancing mixing which is otherwise diffusion-limited. The concept can be effectively used to create a lab-in-a-droplet for MEMS (Micro-Electrical-Mechanical Systems) and Bio-MEMS applications.

### BACKGROUND OF THE INVENTION

1. Field of the Invention

The present invention generally relates to microfabrication technology, and in particular to methods and devices for performing biochemical and other fluidic processes within micron sized droplets.

2. Background Description

Sensor miniaturization is driven by the need to reduce costs by reducing the consumption of reagents, decreasing analysis times, increasing (mixing and separation) efficiency and to enable automation. Such needs, accompanied by the recent advancements in microfabrication technology have led to the development of micro-total analytical systems (μ-TAS). These have a very reduced size and are capable of performing all sample handling steps together with the analytical measurement.

Microfluidic devices involving chemical reactions have a large number of applications including multi-step chemical synthesis, bioanalytical diagnostics, DNA analysis, catalytic hydrogenation of alkenes, acid/base titrations, etc. Fluid mixing is also required for lab-on-a-chip (LOC) platforms for complex chemical reactions. For instance, rapid mixing is essential in many microfluidic systems for proper biochemical analysis, sequencing or synthesis of nucleic acids, and for reproducible biological processes that involve cell activation, enzyme reactions, and protein folding.

At very small length scales, species transport becomes dominated by molecular diffusion that is generally very slow in comparison with the flow residence time. The slow mixing of reagents in microchannels often introduces a high degree of uncertainty about the starting time of the reaction. In general it requires unacceptably long path lengths that range up to several millimeters for moderate flow rates (velocities ˜0.25-1 mm/s) in 200 μm channels. Achieving reasonably fast mixing is, therefore, a major challenge for microfluidic applications. Micromixers can either be integrated into these systems or can work as stand-alone devices. Most miniaturized biochemical sensors developed thus far include a steady flow microfluidic device that requires relatively large sample and reactant volumes to ensure continuous flow.

Active or passive mixers can generate transverse components of flow to induce mixing over relatively short distances. Active devices can be based on rotating magnetic micro-bars that stir the flow, acoustic cavitation cells, and pneumatically pumped rings. These components require power and are complex. Hence, their integration into □-TAS is challenging. These active devices can benefit from a simple “action-from-a-distance” solution that eliminates on-the-chip complexity and reduced the need to integrate a power supply into the microfabricated device (for example, on the substrate itself).

Passive devices, on the other hand, achieve mixing more simply, e.g., through the use of channels with elaborate designs. These mixers are easier to integrate, but have low efficiencies as compared to active systems. Also, passive mixing requires relatively large path lengths and elaborate structures. For instance, although three-dimensional (3D) serpentine passive mixers can have high efficiencies, they require relatively long (˜1 cm) path lengths and work best at high Reynolds numbers (>5) for channel dimensions ˜100-200 μm. One alternative is to create multiple (2-30) compact substream flows that intersect one another. However, due to small channel dimensions, the finer structures generating the substream flows must be patterned with a resolution that is substantially higher than for the channels, which is problematic.

### SUMMARY OF THE INVENTION

We propose an alternative solution in which external magnetic fields are used to produce “action-from-a-distance” at the microscale. The substances or reactants to be mixed are confined in picoliter-size droplets, effectively producing a lab-in-a-droplet. The picoliter droplets could rest on a substrate, be immersed in an immiscible buffer, or even be transported through a microchannel by an immiscible host fluid. Microdroplets containing reactants have been used in a freeze-quenching device to trap metastable intermediates obtained during a fast chemical reaction. Bioanalytical diagnostics involving immunomagnetic separation can also be performed in such a droplet. Alternating magnetic fields have been used to influence particle dynamics in the form of porous packed beds in microchannels with a view to increase fluid-particle interaction.

An aspect of the invention is a method for mixing one or more substances in a droplet, comprising the steps of adding magnetic or magnetizable particles to the droplet, then exposing the droplet to a magnetic field strong enough to cause the particles to form chain-like structures aligned with the magnetic field, and then rotating the magnetic field so that the chain-like structures rotate synchronously with the magnetic field, thereby mixing the substances in the droplet.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram of the experimental setup.

FIG. 2 is a photographic representation showing (a) self organization of magnetic microspheres in a 500 μm diameter droplet into anisotropic chains under an external magnetic field. The microspheres contain magnetic nanoparticles that are covered with silica foam to produce a ˜1 μm magnetic particle (PMSi-H1.0-5, Corpuscular Inc.). (b) When the imposed magnetic field is rotated, the particle chains also rotate synchronously.

FIG. 3 is a series of photographic representations of microspheres showing initial stages of the mixing of a dye in a 500 μm droplet using the lab-in-a-droplet concept. Image sequences (0.065 s. intervals) are presented from left to right in a row followed by subsequent rows. The total duration of the image sequences is approximately 2.6 s.

### DETAILED DESCRIPTION OF A PREFERRED EMBODIMENT OF THE INVENTION

The invention contemplates using magnetic forces to achieve mixing within one or more droplets. A “drop” or “droplet” is a small volume of liquid (e.g., submicron size in diameter or smaller to several hundred microns in diameter or larger, and as a particular example 500 micron diameter droplets have volumes on the order of picoliters and these sized droplets have particular application in the practice of the invention) bounded completely or almost completely by free surfaces. The experimental evidence discussed below is shown for an ideal droplet. However, the phenomenon occurring inside the droplet is found to be a fundamental one, one that may be induced in any body of fluid surrounding a self assembled chain of magnetic particles. Thus, in the practice of this invention, the droplet may be conceived of as sitting in a quiescent atmosphere with completely free surfaces exposed to the atmosphere. It may also be thought of as placed within another liquid. Two situations arise. Either the two fluids may be miscible or immiscible. In either situation, the functionality of the idea remains unaltered.

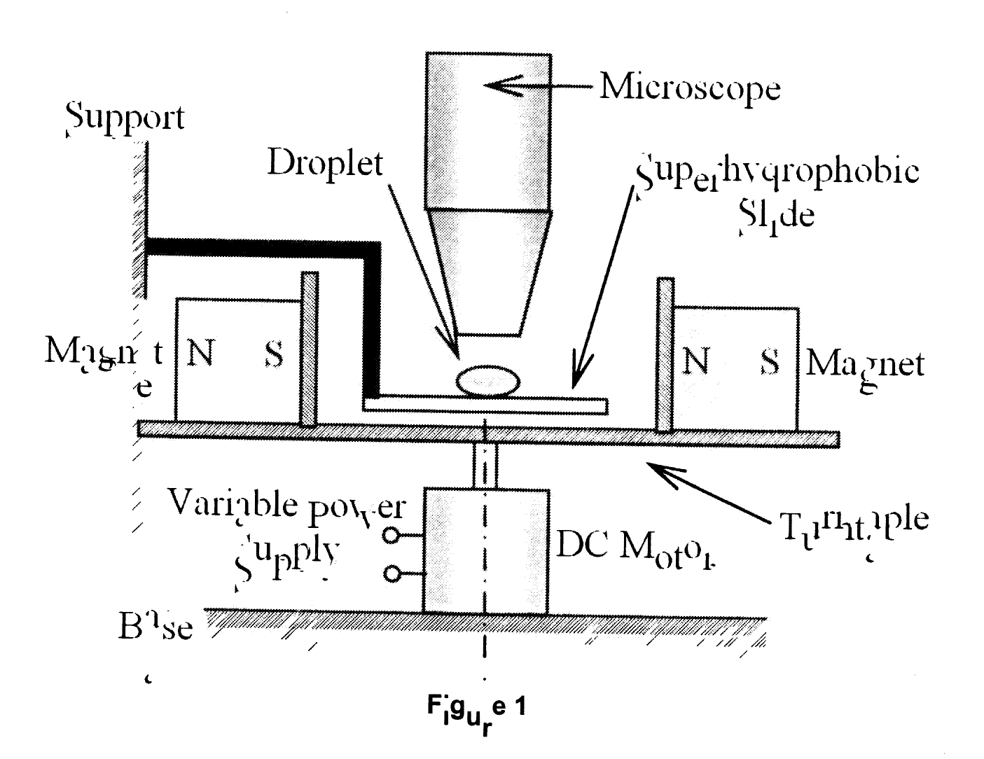

Referring now to the drawings, and more particularly to FIG. 1, there is shown a schematic of a representative experimental configuration used in the invention. A 500 μm diameter water droplet is deposited on a superhydrophobic substrate. Magnetic microspheres (˜1 μm diameter polystyrene beads containing magnetic nanoparticles, PMSi-H1.0-5, Corpuscular Inc.) are then added to the droplet. Next, the droplet-microsphere suspension is subjected to a nearly uniform magnetic field of 0.5 T by placing it between two aligned NdFeB permanent magnets (2.5 mm×2.5 mm×2.5 mm) that are mounted on a turntable. The turntable is rotated about its axis with a specified angular speed (˜2.5 rev. per second), producing a rotating magnetic field. A digital stereo microscope is used to record the images. Standard food coloring agent is added to the droplet in order to visualize the mixing. The smallest water droplets realized was 500 μm. Although smaller droplets could be obtained using smaller diameter dispensers, the extent of mixing (which is a volumetric phenomenon) would remain same for a given particle concentration.

While there has been considerable research on enhancing mixing in microchannels, control over the mixing inside a microdroplet has not been well investigated. One procedure uses chaotic mixing by passing a droplet through serpentine microchannels, which leads to improved mixing through stretching and folding. However, the technique requires complex microchannel design and an elaborate flow system.

The lab-in-a-droplet technique uses active control for mixing in the picoliter size droplets using magnetic microspheres, but does not necessarily require the integration of a power source into a microfluidic device. The microspheres are polystyrene beads with embedded superparamagnetic ferrous nanoparticles. Under a homogeneous magnetic field (B₀=μ₀H₀, where, μ₀ denotes the permeability in vacuum), there is no net unbalanced force on an isolated particle. However, in a system of particles (as there would be in the droplet), a dipole-dipole interaction occurs, since a magnetic dipole moment \vec{m}= 4/3πa³χ_{eff}\vec{H}₀ is induced in each microsphere (where a denotes the particle radius and χ_{eff} the effective susceptibility of the bead). For any two particles separated by a distance r, the interaction energy is

$${U}_{mag} = \frac{{μ}_{0} {μ}_{r}}{4 π} {\vert \vec{m} \vert}^{2} \frac{( 1 - 3 {cos}^{2} α )}{{r}^{3}} , \qquad ( 1 )$$

where μᵣ represents the relative permeability of the liquid in which the beads are suspended and α the angle between the magnetic field vector and the radius vector connecting the two particles. The relation shows that the dipole-dipole interaction force F (˜∇U_{mag}) is attractive and scales as 1/r⁴, implying that the force becomes much stronger as two microspheres more closely approach each other.

Hence, in a strong magnetic field, the microspheres form chain-like structures. The natural tendency of these microsphere-chains is to align themselves with the direction of the imposed magnetic field. If the magnetic field is rotated, the chains also follow its orientation. When this occurs, the chain of N spherical particles experiences a magnetic torque Γₘ and an opposing viscous drag Γᵥ according to the relations

$$\begin{matrix}{Γ}_{m} = \frac{{μ}_{0} {μ}_{r}}{4 π} \frac{3 {\vert \vec{m} \vert}^{2} {N}^{2}}{2 ( 2 {a}^{3} )} sin ( 2 α ) , and & ( 2 ) \\ {Γ}_{v} = \frac{4}{3} N π {a}^{3} \frac{2 {N}^{2}}{ln ( N / 2 )} η ω . & ( 3 )\end{matrix}$$

Here, η denotes the fluid viscosity and ω the angular velocity of the chains. The response of the microbeads to the magnetic force is characterized by the Mason number

$$Ma = \frac{ln ( \frac{N}{2} )}{N} \frac{{Γ}_{v}}{{Γ}_{m}} sin ( 2 α ) = \frac{32 ω η}{{μ}_{0} {μ}_{r} {χ}_{eff}^{2} \vert {\vec{H}}_{0}^{2} \vert} \qquad ( 4 )$$

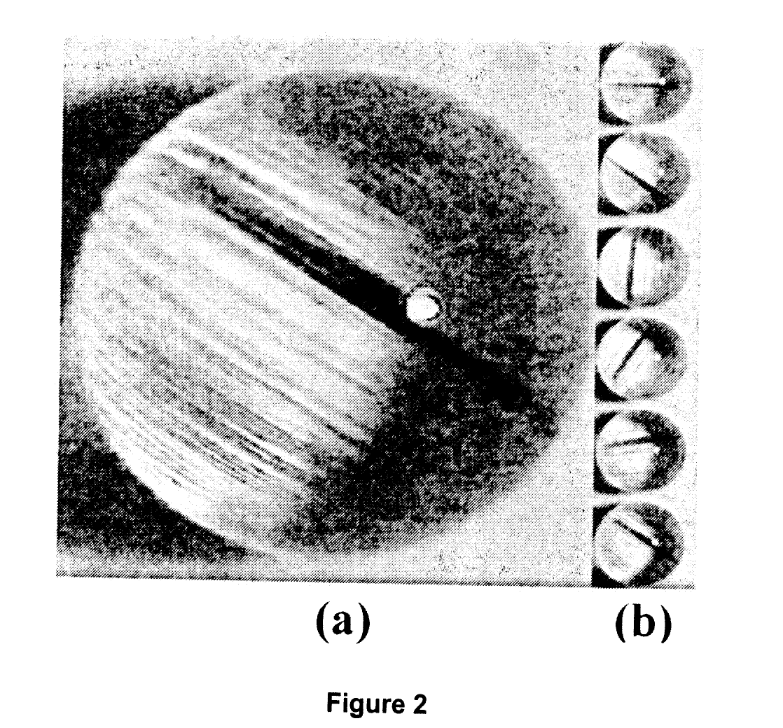

that compares the viscous and magnetic forces. When Ma<<1, the microspheres form long unbroken chains rotating synchronously with the imposed field with a very small angle α (i.e., very closely following the orientation of the imposed rotating magnetic field). One may achieve Ma<<1 with strong magnetic fields, high χ_{eff}, low fluid viscosity, or low rotation rates. FIG. 2 illustrates an example with Ma≈0.025 as a result of the following parameters: η=0.001 Pa s, μᵣ≈1, ω=5π rad/s, χ_{eff}≈0.1, and B₀=0.05 T. Since the viscous torque originates from the interaction between the particles and the host liquid of the droplet, an equal and opposite torque is applied by the particles on the liquid. This induces a rotational motion inside the droplet in the liquid phase. The resulting advection in the droplet can be employed to enhance mixing. Further, since the advective velocity induced in the droplet is proportional to ω, which scales with Ma, the latter is an important parameter for describing the extent of mixing induced in the droplet by the rotating chains. Intuitively, a large value of Ma would induce more convection in the droplet, but the integrity of the chains and their ability to rotate synchronously with the imposed field deteriorate with an increase of Ma.

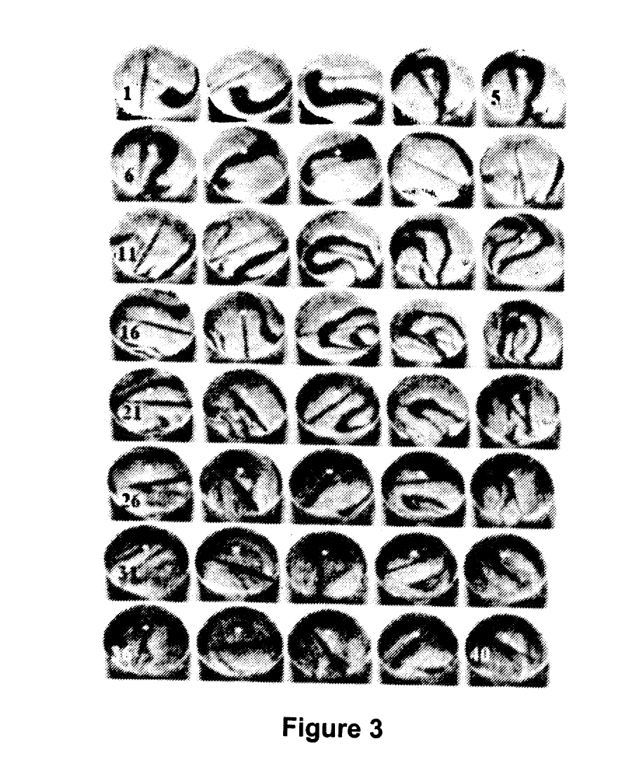

We have obtained images using the lab-in-a-droplet concept described through FIGS. 1 and 2. In order to visualize the mixing, a dye (food coloring) is injected into the droplet containing the microsphere chains and the magnetic field is rotated. The mixing process is demonstrated in FIG. 3. A fluid dye is injected into the droplet (containing the microsphere chains) and the magnetic field is rotated at 2.5 Hz. The images in FIG. 3 were acquired at approximately 0.065 s intervals. Repetitive stretching (image sequences 6-10) and folding (images 11-20) of the dye indicates that mixing is chaotic. This form of mixing increases the surface area of the dyed fluid exponentially, thus greatly enhancing mixing. The sample shown in the figure is completely mixed within 2.6 s (image 40 of FIG. 3).

The mixing process is much faster than by pure diffusion alone. If only diffusive mixing is considered, the mixing time would have been of the order of R²/D, where D denotes the dye diffusivity in water and R the droplet radius. Typically the diffusivity of water soluble molecules (e.g., dyes or ions) ˜10⁻⁹ m²/s. Considering the droplet diameter R˜10⁻³ m, the diffusive mixing time is of the order of 10³ S. Clearly, mixing has been enhanced by almost three orders of magnitude due to the advective mixing induced by the magnetic bead microrotor agglomerates. For larger particles that have a 1-10 μm diameter (e.g., the microbeads) D˜10⁻¹³-10⁻¹⁴ m²/s, and their corresponding diffusion time ˜10⁷-10⁸ s. Hence, actual applications involving the mixing of larger particles would benefit even more from this mixing strategy. Considering that the magnetic beads rotate in synchronism with the rotating magnetic field at ω (=2πn/60, where n is the rotational frequency of the magnetic field in rpm), the average velocity induced in the fluid ū˜ωR/2. In that case the Peclet number describing mixing Pe=ūR/D, i.e., Pe˜ωR²/2D. Assuming that D˜10⁻⁹ m²/s and R˜10⁻³ m, Pe>1 when n>0.02 rpm. Advection-assisted mixing dominates when the angular velocity is greater than this relatively small value. The time required for the field-assisted self assembly of the microspheres, leading to the formation of pearl chains, varies with the magnetic field strength, fluid viscosity and particle size and concentration. For the cases considered the time scale of chain formation was found to be two orders of magnitude smaller than the mixing time scale, and hence the chain formation time has insignificant effect on the mixing time.

The mixing strategy proposed here develops chaotic advection in the droplet caused by rotating chains of magnetic microspheres. For a water-soluble dye, the mixing time is found to reduce by three orders of magnitude. For the mixing of larger particles (e.g., the microspheres, or microorganisms), the technique is expected to be even more effective in reducing the mixing time. Moreover, the extent of mixing can be readily controlled by either altering the particle loading in the droplet or changing the rotational speed of the magnetic field.

Those of skill in the art will recognize that the present invention may be utilized to assess the interaction of many diverse types of substances within a droplet. For example, the method may be used to assess the interactions of various molecules of substances that bind to their complementary molecules on the microspheres, or are candidates for binding to the molecules. Examples include but are not limited to: proteins, receptors and ligands; enzymes and substrates, activators or inhibitors, etc.; binding of various synthetic molecules, e.g. synthetic small molecule drugs; complementary nucleic acids or other substances (e.g. proteins or polypeptides) that bind to nucleic acids; proteins, polypeptides and peptides and various substances that may interact with them (those described above, and also metal ions, various saccharides or polysaccharides, lipids, nucleic acids, other proteins, toxins, antibodies, and the like). In addition, the substances that are analyzed may be whole organisms (e.g. microorganisms such as bacteria, viruses, etc. or components thereof), whole cells or even subcelluar organelles. In addition, the substances may be or may include microparticulate matter, e.g. pollen, minerals, pollutants, and the like. The properties of any material may be assessed by the method of the invention, so long as the material is amenable to inclusion in a droplet of micron-scale dimensions.

Aside from the mixing occurring in droplets as discussed above, the operations involved are quite different from large volume mixing accomplished with, for example, a ‘magnetic stirrer’. Magnetic stirrers are commercially available consisting of a small permanently magnetized bar magnet (or stir bar). This is accompanied with a stand or plate containing a rotating magnet or stationary electromagnets creating a rotating magnetic field. Often, the plate can also be heated. During operation of a typical magnetic stirrer, the bar magnet (or flea) is placed in a vessel containing a liquid to be stirred. The vessel is set on top of the stand, where the rapidly rotating magnetic field causes the bar magnet to rotate. This type of a magnetic stirrer is applicable at large length scales—large volume processing. In contrast, in the microdroplet mixing contemplated herein it should be recognized that the physics of fluid mixing changes dramatically as the length scale is reduced. For example, a 500 μm radius droplet has a volume of the order of pico liters. When working with such low volumes, the functionality of a magnetic stirrer described above falls short.

As demonstrated above, mixing is successfully shown as the chief outcome of the experiments even at such a challenging length scale. Additionally, the chains formed are soft and may be assembled or disassembled on demand with an appropriately designed magnetic field. When using the droplet concept in a droplet-inside-a-fluid situation, the chains may be transported from one point to another—in and out of the droplet. This adds ease of using various differently functionalized particles at different processing times with the same physical device. The mixing can greatly facilitate antibody-antigen coupling, as well as other biologic and chemical reactions. Hence the same device may be used to bind to a variety of pathogens if appropriately functionalized magnetic microspheres are used

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A method for mixing one or more substances in a droplet by inducing advective motion in said droplet, comprising the steps of
adding magnetic or magnetizable particles to said droplet, and
applying a magnetic field to said droplet so as to cause said particles to move in a manner that induces advective motion within said droplet, thereby mixing said one or more substances in said droplet.

2. The method of claim 1, wherein said step of applying a magnetic field causes said particles to form chains aligned with the magnetic field.

3. The method of claim 1, wherein said magnetic field is rotated and said chains rotate synchronously with the magnetic field.

4. The method of claim 1, wherein said droplet is a picoliter-sized droplet.

5. The method of claim 1, wherein said droplet is positioned on a superhydrophobic substrate.

6. The method of claim 1, wherein said droplet is suspended in an immiscible buffer.

7. The method of claim 6, wherein said droplet is transported through a microchannel.

8. The method of claim 1, wherein said particles are magnetic microspheres.

9. The method of claim 1, wherein one of said one or more substances is selected from the group consisting of nucleic acids, proteins, peptides, and metal ions.

10. A method for mixing one or more substances in a droplet, comprising the steps of:
adding magnetic or magnetizable particles to said droplet;
exposing said droplet to a magnetic field strong enough to cause said particles to form chain-like structures aligned with the magnetic field; and
rotating said magnetic field so that said chain-like structures rotate synchronously with the magnetic field, thereby mixing said one or more substances in said droplet.

11. The method of claim 10, wherein the synchronous rotation produces a magnetic torque and opposing viscous drag that induces advective motion within said droplet.

12. The method of claim 10, wherein said droplet is a picoliter-sized droplet.

13. The method of claim 10, wherein said droplet is positioned on a superhydrophobic substrate.

14. The method of claim 10, wherein said droplet is suspended in an immiscible buffer.

15. An apparatus for mixing one or more substances in a droplet, comprising:
means for adding magnetic or magnetizable particles to said droplet;
means for exposing said droplet to a magnetic field strong enough to cause said particles to form chain-like structures aligned with the magnetic field; and
means for rotating said magnetic field so that said chain-like structures rotate synchronously with the magnetic field, thereby mixing said one or more substances in said droplet.

16. The apparatus of claim 18, wherein the synchronous rotation produces a magnetic torque and opposing viscous drag that induces advective motion within said droplet.

17. The apparatus of claim 15, wherein said exposing means comprises:
a turntable mounted horizontally on a motor;
a surface suspended in a plane parallel to said turntable, said droplet being supported by said surface;
a pair of magnets for applying a magnetic field to said droplet causing said particles to form chain-like structures aligned with the magnetic field, said magnets being mounted on said turntable on opposite sides of said suspended surface; and
a support for said suspended surface.

18. The apparatus of claim 17, wherein said rotating means further comprises:
means for controlling a rotation of the turntable by the motor so that said magnetic field applied to said droplet causes said chain-like structures to rotate synchronously with the magnetic field, thereby mixing the substances in the droplet,
wherein the support is positioned so as not to interfere with the magnets when the turntable is rotated by the motor.

19. The apparatus of claim 17, wherein said suspended surface is a superhydrophobic slide.

20. The apparatus of claim 18, wherein the controlling means is operated so that the synchronous rotation produces a magnetic torque and opposing viscous drag that induces advective motion within said droplet.
